(19) United States
(12) Patent Application Publication
(10) Pub. No.: US 2016/0122905 A1
(43) Pub. Date: May 5, 2016

(54) METHOD AND APPARATUS FOR ERROR DETECTION OF POOLING

(71) Applicants: SAMSUNG SDS CO., LTD., Seoul (KR); SAMSUNG LIFE PUBLIC WELFARE FOUNDATION., Seoul (KR)

(72) Inventors: Chang Seok KI, Seoul (KR); Woo Yeon KIM, Seoul (KR); Yoo Jin HONG, Seoul (KR); Yong Seok LEE, Seoul (KR); Seong Hyeuk NAM, Seoul (KR)

(73) Assignees: SAMSUNG SDS CO., LTD., Seoul (KR); SAMSUNG LIFE PUBLIC WELFARE FOUNDATION., Seoul (KR)

(21) Appl. No.: 14/927,878

(22) Filed: Oct. 30, 2015

(30) Foreign Application Priority Data
Oct. 31, 2014 (KR) 10-2014-0150322

(51) Int. Cl. C40B 30/02; G06F 19/24

(52) U.S. Cl. CPC C40B 30/02; G06F 19/24

(57) ABSTRACT

A method for detecting a pooling error including the steps of determining an expected number of normal chromosome strands of a plurality of samples contained in a first pool based on ploidy types of the plurality of samples, determining whether a number of normal chromosome strands is different from the expected number of chromosome strands determined based on base sequences of the plurality of samples contained in the first pool, determining whether pooling is equilibrated based on an allele frequency value for a standard variant of the first pool, and detecting a pooling error using results of the determining the number of normal chromosome strands and the determining whether the pooling is equilibrated.

### CROSS-REFERENCE TO RELATED APPLICATION

This application claims priority from Korean Patent Application No. 10-2014-0150322 filed on Oct. 31, 2014 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a method and apparatus for pooling error detection, for detecting whether an error is generated because a plurality of biological samples are not quantitatively pooled in pooling tests of the biological samples. More particularly, the present invention relates to a method and apparatus for pooling error detection for determining whether pooling is equilibrated by constituting chromosomes of biological samples and classifying pooled samples based on base sequences of the chromosomes.

2. Description of the Related Art

Technology for collecting biological samples including base sequences of an organism is provided to examine whether the organism is infected with a particular virus or has a genetic variant causing a particular diseases.

However, individually examining the biological samples may incur considerable time and cost. Therefore, in order to reduce the incurred time and cost, methods for pooling multiple biological samples and examining the pooled samples at the same time are proposed.

In order to obtain accurate test results of such pooling tests, it is necessary to pool the biological samples in an equilibrated manner. However, there exist no methods for determining whether pooling of the biological samples is equilibrated, and reliability of the pooling test results is hardly attained.

Therefore, in pooling tests for simultaneously examining multiple gene samples, it would be desired to provide technology for detecting whether some of samples contained in pools are left out or whether the samples are pooled in an equilibrated manner even if no samples are left out.

### SUMMARY

The present invention provides a method and apparatus for detecting a pooling error in consideration of the number of chromosome strands to determine a pooling extent of samples for attaining reliability of pooling test results.

The present invention also provides a method and apparatus for pooling error detection for determining whether there are samples left out or pooling of samples is insufficient by measuring the number of chromosome strands of the samples when abnormal pooling is detected in a pooling test.

The present invention also provides a method for determining the minimum number of comparison regions on a reference sequence for classifying chromosome strands of pools into groups of chromosome strands having different base sequences based on the reference sequence.

These and other objects of the present invention will be described in or be apparent from the following description of the preferred embodiments.

According to an aspect of an exemplary embodiment, there is provided a method for detecting a pooling error including: determining an expected number of normal chromosome strands of a plurality of samples contained in a first pool based on ploidy types of the plurality of samples; determining whether a number of normal chromosome strands is different from the expected number of chromosome strands determined based on base sequences of the plurality samples contained in the first pool; determining whether pooling is equilibrated based on an allele frequency value for a standard variant of the first pool; detecting a pooling error using results of the determining the number of normal chromosome strands and the determining whether the pooling is equilibrated; and generating an output signal corresponding to determining whether the pooling error is detected.

The determining the number of the normal chromosome strands in the first pool may include: receiving base sequence data for a plurality of reads corresponding to the plurality of samples contained in the first pool; grouping a sample-specific variant group of the plurality of reads, the sample-specific variant group of reads having base sequences corresponding to a preset specific variant among the plurality of reads; establishing a window region for a reference base sequence as a basis for determining whether there is a variable; grouping a remaining group of the plurality of reads, the remaining group of reads having a same variant in the window region of the reference base sequence, and not belonging to the sample-specific variant group; and calculating the normal number of chromosome strands in the first pool according to the total number of groups based on the grouping the sample-specific variant group and the grouping the remaining group of the plurality of reads.

The establishing the window region may include establishing the window region to have a minimum number of required variants calculated by the following formula:

$$minimum number of required variants = {log}_{( A )} \frac{C}{B} ,$$

where A represents a number of combinations of alleles, B represents a variant occurrence frequency, and C represents a number of chromosome strands contained in the first pool.

The grouping the remaining group of the plurality of reads may include: shifting the window region; and in response to chromosome strands belonging to one group in the window region of the shifted reference base sequence have different variants, dividing the chromosome strands belonging to one group into two or more groups.

The determining whether the pooling is equilibrated may include: obtaining a plurality of base sequences corresponding to the standard variant; measuring a number of chromosome strands having the plurality of base sequences corresponding to the standard variant; and determining whether pooling is equilibrated using the allele frequency, pools in which the measured number of chromosome strands corresponds to the standard variant, and the determined expected number of chromosomes.

The detecting the pooling error may include: in response to the pooling being determined to be equilibrated, determining the pooling as normal pooling; in response to the pooling being determined not to be equilibrated and the determining the number of normal chromosome strands indicating that the number of normal chromosome strands is equal to the expected number of chromosome strands contained in the first pool, determining that particular samples are pooled in a smaller quantity than a quantification limit in the pooling, and determining that there are errors in the pooling.

The determining that particular samples are pooled in the smaller quantity than the quantification limit in the pooling, may further include discriminating the particular samples by comparing the number of chromosome strands contained in the first pool with a second number of chromosome strands and a second allele frequency of a second pool crossing the first pool on a two dimensional matrix.

According to an aspect of another exemplary embodiment, there is provided an apparatus for detecting a pooling error including: at least one processor; a network interface; a memory; and a storage device loaded on the memory and having a computer program recorded therein executable by the at least one processor, wherein the computer program causes the apparatus to execute: calculating an expected number of chromosome strands of a plurality of samples in a first pool based on ploidy types of the plurality of samples, detecting chromosome strands having different genotypes based on genotypes of the plurality of samples, and determining whether the number of detected chromosome strands is different from the expected number of chromosome strands; extracting an allele frequency value for a standard variant from the first pool and determining whether the pooling is equilibrated based on the allele frequency value; determining whether a pooling error is detected based on the determining whether the number is detected chromosome strands is different and the determining whether the pooling is equilibrated; and generating an output signal corresponding to the determining whether the pooling error is detected.

According to an aspect of yet another exemplary embodiment, there is provided a method for determining a number of haplotypes contained in each of a plurality of pools, the method including: receiving base sequence data of a plurality of reads respectively contained in each of the plurality of pools; constructing a corresponding plurality of chromosome strands contained in each of the plurality of pools using the corresponding base sequence data for each of the respective reads; designating a corresponding remaining group of the plurality of chromosome strands, excluding reads having base sequences corresponding to a preset specific variant, among the corresponding constructed plurality of chromosome strands, as corresponding chromosome strands to be classified; establishing a corresponding window region for each of the plurality of pools as a reference base sequence as a corresponding basis for variable determination; classifying the corresponding chromosome strands to be classified into corresponding groups of chromosome strands having the same variant based on DNA base sequences in the corresponding window region of the reference base sequence; calculating the corresponding number of chromosome strands in each of the plurality of pools based on the corresponding classifying result; and generating a plurality of output signals corresponding to the calculating the corresponding number of chromosome strands in each of the plurality of pools.

The establishing the corresponding window region of the reference sequence may include establishing a corresponding minimum number of required variants calculated by the following formula:

$$minimum number of required variants = {log}_{( A )} \frac{C}{B} ,$$

where A represents a number of combinations of alleles, B represents a variant occurrence frequency, and C represents a number of chromosome strands contained in the corresponding pool.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a sample pooling process for generating data to be analyzed in a method for pooling error detection in consideration of the number of chromosome strands according to an embodiment of the present invention;

FIG. 2 is a schematic diagram of a sample analysis system according to an embodiment of the present invention;

FIG. 3 is a schematic diagram of a sample analysis system according to another embodiment of the present invention;

FIG. 4 is a block diagram of a pooling error detection apparatus according to an embodiment of the present invention;

FIG. 5 is a flowchart illustrating a method for pooling error detection in consideration of the number of chromosome strands according to an embodiment of the present invention;

FIG. 6 is a flowchart illustrating a process of analyzing chromosome strands on the basis of a base sequence in the method illustrated in FIG. 5;

FIG. 7 is a flowchart illustrating a process of classifying haplotypes on the basis of a window region of a reference base sequence according to an embodiment of the present invention;

FIG. 8 is a diagram illustrating a process of determining whether pooling is equilibrated from allele frequency according to an embodiment of the present invention;

FIG. 9 is a diagram illustrating a method for determining ploidys for explaining sample ploidy designation;

FIGS. 10 and 11 illustrate examples of cases where samples with pooling errors cannot be discriminated and where samples with pooling errors can be discriminated in the method for pooling error detection according to an embodiment of the present invention; and

FIG. 12 is a hardware diagram of a pooling error detection apparatus according to an embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, the size and relative sizes of layers and regions may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terminology used herein is for the purpose of describing particular embodiments only and is not intended to be limiting of the invention. As used herein, the singular forms are intended to include the plural forms as well, unless the context clearly indicates otherwise.

First, the following definitions are provided to facilitate understanding of terms used throughout this specification.

The term “pool” refers to a collection of a plurality of biological samples constructed by arranging the plurality of biological samples on a two dimensional matrix and grouping the biological samples belonging to the same column or the same row.

The term “ploidy type of a sample” refers to the number of chromosome strands contained in biological samples, which varies according to kinds of ploidy, including a diploid type and a haploid type.

The term “variant” refers to a biological sample having a base sequence different from a reference base sequence, and the term “standard variant of a pool” refers to a particular trait to be detected from the biological sample.

The term “allele frequency value” refers to a ratio of the number of samples having base sequences representing the standard variant to the total number of biological samples contained in a pool.

The term “the number of chromosome strands of a pool” refers to a value obtained by adding numbers of chromosome strands contained in a pool, which vary according to ploidy types of the samples.

The term “specific variant” refers to a variant having a different base sequence from the reference base sequence, unlike the standard variant, and occurring to only one of the samples contained in the pool.

The term “base sequence” refers to a sequence of DNA codes of a chromosome, consisting of four different nucleotide bases denoted by A, G, C and T.

The term “window region” refers to an region of the reference base sequence, from which a variant is to be detected. It is detected from the reference base sequence whether the chromosome has a different variant by comparing base sequences in a particular region, instead of comparing the entire reference base sequence at a time. An region having high heterogeneity is preferably selected as the window region.

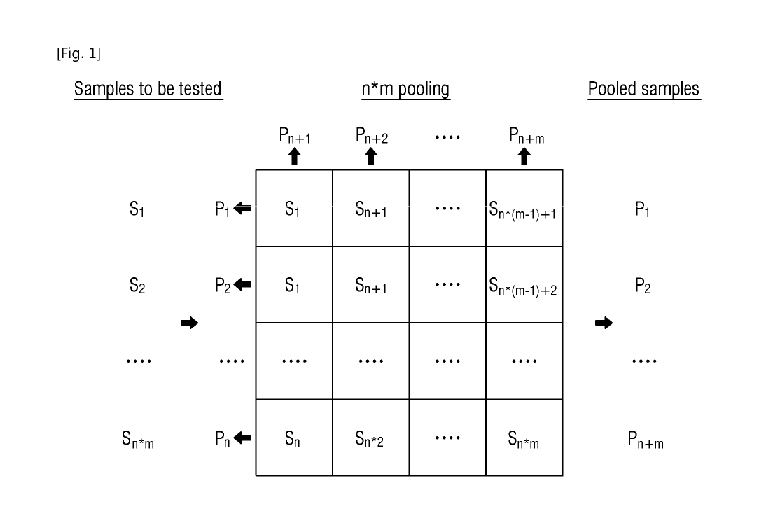

Hereinafter, a process of constructing pools from samples to be tested will be described with reference to FIG. 1.

First, X (X=n*m) samples to be tested (S₁, S₂, S₃, . . . , S_{n*m}) are arranged on a n*m matrix. Here, n and m may be equal to or different from each other. However, n*m should be equal to X, which is greater than or equal to 2. The samples to be tested are samples to be examined whether they have particular biological traits and may include tissues or body fluids of all kinds of organisms, including humans.

After the matrix is constructed, the X samples arranged on the matrix are pooled by dividing the X samples in k (=n+m) pools. Here, the samples having the same row or the same column on the matrix are pooled in the same pool. For example, in the illustrated embodiment, samples of the first row of the matrix are pooled in a pool P 1, and samples of the first column of the matrix are pooled in a pool Pₙ₊₁. Through this procedure, k pools of samples (P₁, P₂, P₃, . . . , P_{n*m}, each of which is to be briefly denoted by “pool”) are generated.

The samples pooled as illustrated in FIG. 1 may be tested whether they have particular traits, that is, they are samples having a standard variant. when samples having a standard variant are discriminated through pooling tests, the standard variant preferably has a low positive frequency. The term “positive frequency” used herein is a statistical concept representing occurrences of the samples having a standard variant.

In order to detect which one of the pooled samples has a standard variant in a pooling test for simultaneously testing multiple samples, a sample having a highly accurate standard variant can be detected when the sample is singly discriminated from an intersection of row and column on the two dimensional (2D) matrix.

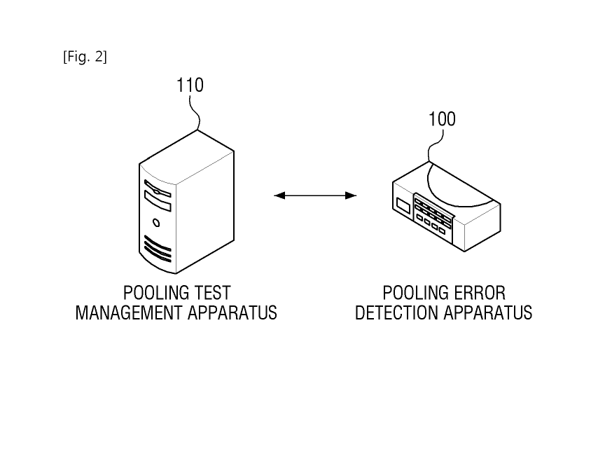

Hereinafter, the configuration and operation of a sample analysis system according to an embodiment of the present invention will be described with reference to FIG. 2. The sample analysis system according to an embodiment of the present invention includes a pooling test management apparatus 110 and a pooling error detection apparatus 100.

The pooling test management apparatus 110 is an apparatus for pooling a plurality of biological samples to construct pools of a 2D (n*m) matrix and testing whether the pools have particular biological traits. The pooling test management apparatus 110 may record data concerning each of the biological samples, e.g., data of blood collected from a human. The pooling test management apparatus 110 is configured to determine positive samples using the pools crossing each other on the matrix when a certain one of the pools demonstrates a positive reaction satisfying a particular biological trait.

The pooling error detection apparatus 100 is an apparatus for detecting positive reaction result values for pool specific variants of the matrix pools of the biological samples from the pooling test management apparatus 110. The pooling error detection apparatus 100 determines pooling adequacy by constructing chromosome strands of the pools, grasping base sequences of the chromosome strands and comparing the number of chromosome strands having base sequences demonstrating the standard variant with allele frequency data for the standard variant.

When the number of chromosome strands having base sequences demonstrating the standard variant is smaller than allele frequencies, the pooling error detection apparatus 100 may determine that there are samples left out in pooling or the samples are pooled in a smaller quantity than a quantification limit.

When the pooling error detection apparatus 100 discriminates the samples determined to be left out in pooling or the samples pooled in a smaller quantity than the quantification limit, the pooling test management apparatus 110 determines that the pooled samples are to be reexamined for standard variant detection.

However, when the pooling error detection apparatus 100 is incapable of discriminating abnormally pooled samples, the pooling test management apparatus 110 reexamines all of the samples in the pools for standard variant detection.

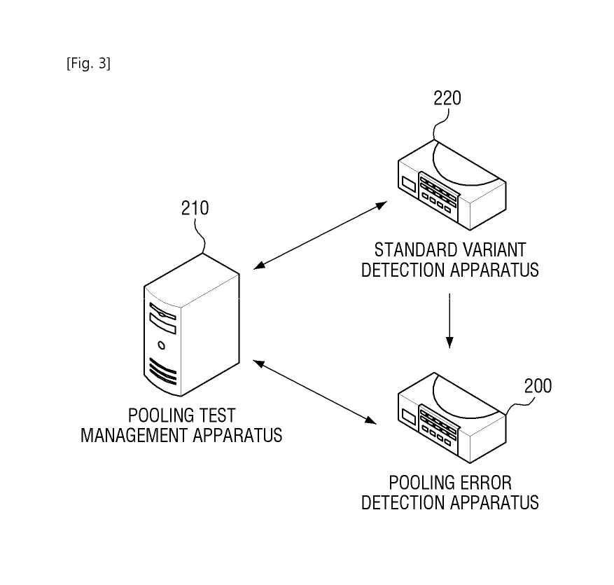

FIG. 3 is a schematic diagram illustrating the configuration and operation of a sample analysis system according to another embodiment of the present invention.

The sample analysis system according to another embodiment of the present invention may include a pooling error detection apparatus 200, a pooling test management apparatus 210, and a standard variant detection apparatus 220.

The pooling test management apparatus 210 may manage individual data of the samples arranged on the 2D (n*m) matrix. In addition, the pooling test management apparatus 210 may store data concerning allele frequency values of the respective pools.

In order to measure standard variant genotype signals, the standard variant detection apparatus 220 may employ next generation sequencing (NGS). The NGS allows reads corresponding to sequence fragments having constant lengths with respect to a targeted DNA region to be produced in large quantities. The thus produced reads are mapped to the reference sequence, and sequences of the corresponding region are reconstructed based on the sequence data of the reads mapped in a particular region.

In the above-described example, a genotype at a particular position for a sample to be tested can be analogized from the allele frequencies at corresponding positions of the reads mapped in the region including the corresponding positions. For example, in a case of a heterozygous genotype AB, the allele frequencies of A and B will be observed to be approximately ½ and ½, respectively. In addition, in a case where samples having genotypes AB and BB are pooled, the allele frequencies of A and B will be observed to be approximately ¼ and ¾, respectively. Therefore, in order to test whether a sample has a particular single base variant using the NGS, the allele frequency of the allele B present in the variant genotypes AB and BB is measured based on the mapped reads.

Meanwhile, when of a diploid sample has a genotype AB in obtaining the allele frequencies based on the mapped reads using NGS, the allele frequency for the replaced allele B may not be always observed to be ½ or 1 in some case. This may be caused due to several errors, such as a sequencing error or a mapping error. Therefore, when the allele frequency is observed to be in the range of between 0.4 and 0.6 with such errors taken into consideration, the sample is determined to have the genotype AB, and when the allele frequency is observed to be 0.8 or greater, the sample is determined to have the genotype BB. Accordingly, the rule may be applied to the samples such that the samples are assigned with the respective genotypes based on the determination results. Another approach for determining genotypes of samples based on the mapped reads may include statistical algorithm for computing a likelihood or a probability for a certain genotype, such as an SNVer algorithm (Wei et al., SNVer: a statistical tool for variant calling in analysis of pooled or individual next-generation sequencing data, Nucleic Acids Res. 39(19), 2011). The test result values may also be determined using the rule or algorithm in consideration of the number of pooled samples. However, the rule or algorithm may be provide only for an embodiment for implementing the present invention, but aspects of the present invention are not limited thereto.

In order to facilitate application of the NGS to the present invention, the sequencing results of the respective pools should satisfy the condition that sequenced reads of the samples pooled in the respective pools are distributed in an equilibrated manner. For example, assuming that four pooled samples have genotypes AA, AB, AB and AA, respectively, the allele frequency for the replaced allele B should be observed to be approximately 2/8 in the corresponding pool.

The pooling error detection apparatus 200 may receive allele frequency values and base sequence data of the respective pools from the pooling test management apparatus 210. In addition, the pooling error detection apparatus 200 may receive from the standard variant detection apparatus 220 information on the position of the reference base sequence based on the read having the standard variant. When a pooling error is detected by constructing chromosome strands, the pooling error detection apparatus 200 may use the position information received from the standard variant detection apparatus 220.

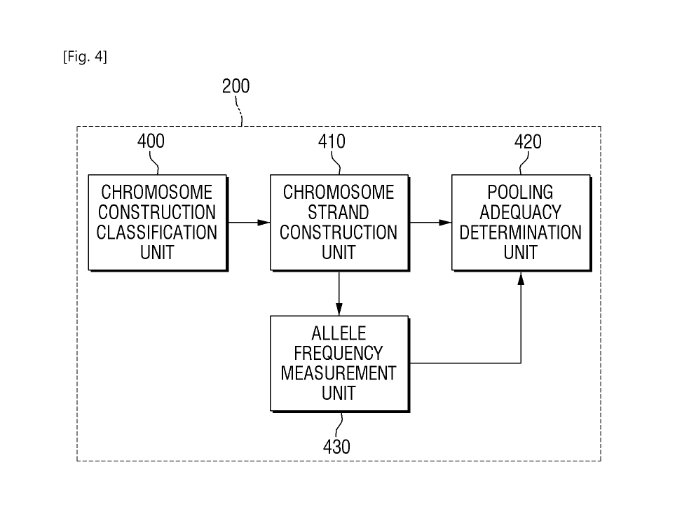

FIG. 4 is a block diagram of a pooling error detection apparatus (200) according to an embodiment of the present invention.

The pooling error detection apparatus 200 may include a chromosome construction classification unit 400, a chromosome strand construction unit 410, a pooling adequacy determination unit 420, and an allele frequency measurement unit 430.

The chromosome construction classification unit 400 compares base sequence data of chromosome strands of the respective pools with the reference base sequence and classifies the chromosome strands having the same variant as the same group.

In order to classify the chromosome strands of the respective pools, the chromosome construction classification unit 400 may employ genome sequencing. First, the chromosome construction classification unit 400 generates data of base sequences having short lengths, called “reads,” from the chromosome strands of the respective pools by means of a genome sequencer. Here, reads having different base sequences from the reference base sequence may be detected by performing mapping based on the reference base sequence and variant base sequences may also be detected. Reckoning that the reads having the same variant base sequence are of the same haplotype, the chromosome construction classification unit 400 may calculate the number of haplotypes of each pool after the classifying is completed.

The chromosome strand construction unit 410 may construct chromosome strands of the respective pools. One chromosome strand may be constructed based on the information on reads contained in the haplotype. Techniques for reconstructing the reads contained in the haplotype may include generating reconstructed reads after removing redundant information among the reads.

The allele frequency measurement unit 430 may receive base sequence data representing the standard variant from the pooling test management apparatus 210 or the standard variant detection apparatus 220. The allele frequency measurement unit 430 receives the base sequence data of the chromosome strands of the respective pools from the chromosome strand construction unit 410 and determines whether the base sequences include the standard variant. The allele frequency measurement unit 430 may measure allele frequencies based on weights of the chromosome strands having the standard variant relative to the number of the chromosome strands of the respective pools.

The pooling adequacy determination unit 420 determines pooling adequacy by comparing the allele frequency data of the standard variant, received from the pooling test management apparatus 210, with the allele frequency value measured based on the number of chromosome strands having base sequences demonstrating the standard variant, received from the allele frequency measurement unit 430.

When the pooling is determined not to be equilibrated in the determining of the pooling adequacy using the allele frequency data using, the pooling adequacy determination unit 420 may receive data concerning the number of haplotypes from the chromosome construction classification unit 400. The pooling adequacy determination unit 420 may receive ploidy data of the samples contained in the respective pools from the pooling test management apparatus 210 and may determine the expected number of normal chromosome strands.

According to the determination result as to whether the number of haplotypes detected is equal to the number of normal chromosome strands, the pooling adequacy determination unit 420 may determine whether the pooling error is caused by left-out samples or by insufficiency of a quantification limit.

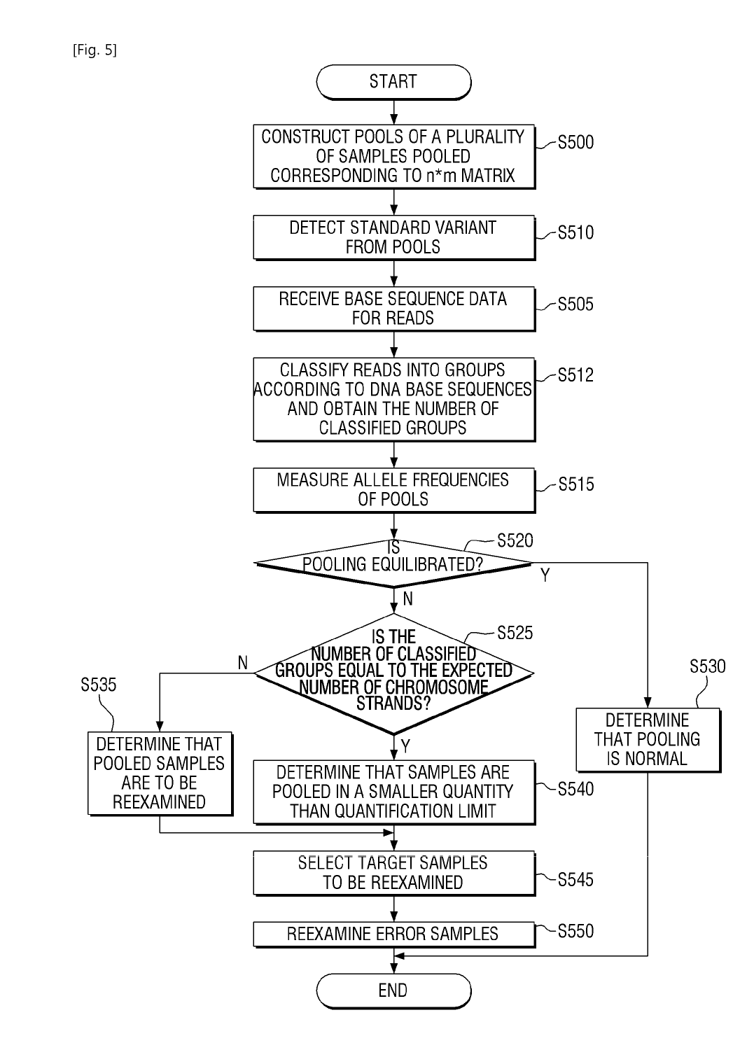

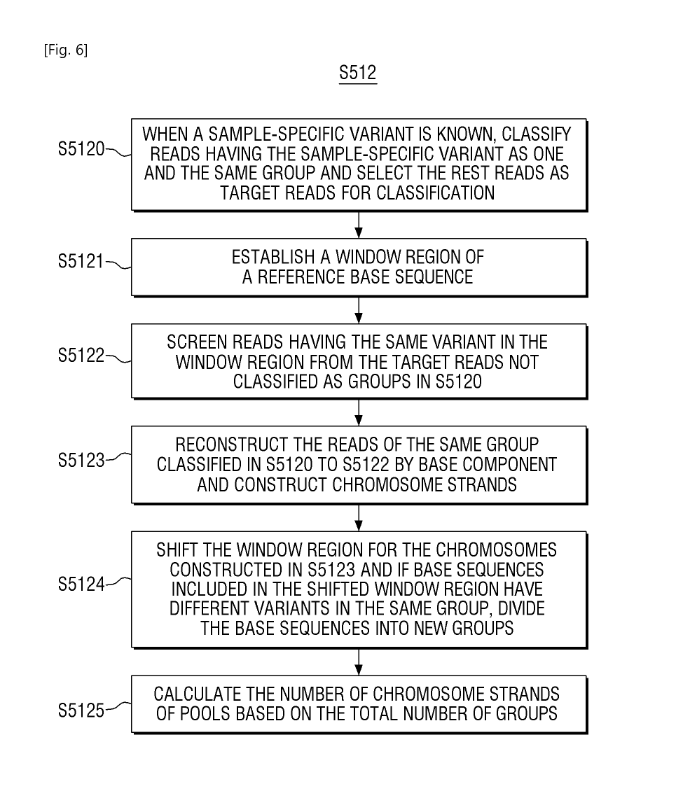

Hereinafter, a method for pooling error detection according to an embodiment of the present invention will be described with reference to FIGS. 5 and 6. The method for pooling error detection may be executed by a computing device. The computing device may include the pooling error detection apparatuses 100 and 200 illustrated in FIGS. 2 and 3. In the following description, functional elements performing various operations included in the method for pooling error detection may not be described for a better understanding of the invention.

The method for pooling error detection will now be described with reference to FIG. 5. Pools are constructed by a plurality of samples pooled corresponding to a 2D matrix (S500). Next, a standard variant is detected from the pool (S505). Next, base sequence information for reads contained in the pool is received (S510). Next, the reads are classified into groups according to DNA base sequences and a final number of classified groups to identify the number of haplotypes (S512).

A group of reads having the same base sequence may be regarded as being of the same haplotype. In S512, the number of haplotypes is obtained from base sequence data of the chromosome strands contained in the pools.

Pooling tests of the respective pools may be performed to determine whether pooling is equilibrated or not by comparing the allele frequency values measured in S505 with the allele frequency values obtained by constructing the chromosome strands and measuring the same from the number of chromosome strands having standard variant base sequences.

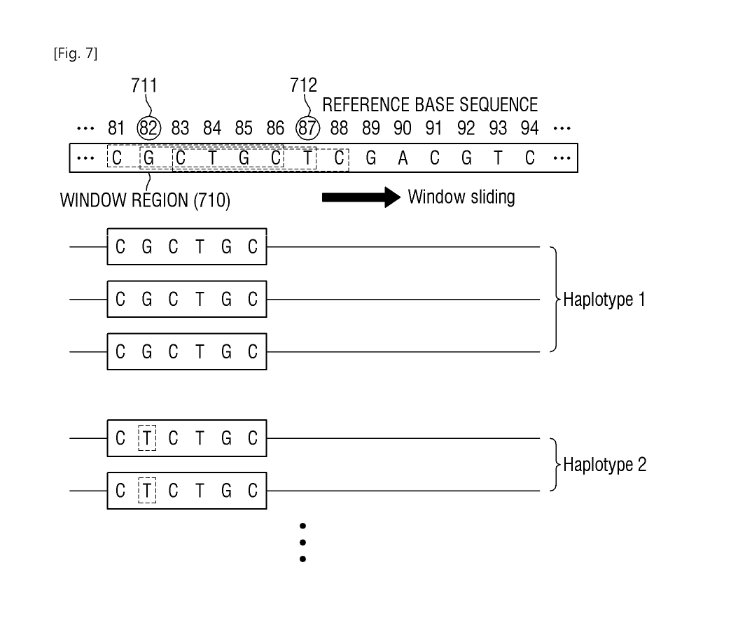

Therefore, in S515, the allele frequencies of the respective pools are measured based on the base sequence data of the chromosome strands constructed for the respective pools (S510). The reads having standard variant base sequences can be isolated from the chromosome strands by mapping with the standard variant DNA, which will later be described in more detail with reference to FIG. 7. The allele frequencies of the respective pools are measured based on weights of the isolated chromosome strands relative to the total number of chromosome strands contained in the pools (S515).

In S520, it is determined whether pooling is equilibrated or not by comparing the allele frequency measured in S505 with the allele frequency value obtained from the number of chromosome strands. According to another embodiment of the present invention, if the number of chromosome strands mapped with the standard variant base sequence is different from a multiplication product of numbers of chromosome strands contained in the respective pools at the allele frequency obtained in S505, it may be determined that pooling of each pool is not equilibrated (S520, S525). However, if the number of chromosome strands mapped with the standard variant base sequence is equal to the multiplication product of numbers of chromosome strands contained in the respective pools at the allele frequency obtained in S505, it may be determined that pooling of each pool is equilibrated (S520, S530).

If pooling of each pool is determined to be equilibrated, it is determined that the pooling is normal (S530). However, if pooling of each pool is determined not to be equilibrated, it is determined whether the number of classified groups of the chromosome strands is equal to the expected number of chromosome strands (S525). Here, the expected number of chromosome strands may be determined based on the ploidy data for the samples contained in the respective pools. If the detected number of classified groups is not equal to the expected number of chromosome strands, it is determined that there are samples left out in pooling (S525, S535).

However, when it is determined that the number of classified groups of the chromosome strands is equal to the expected number of chromosome strands even if pooling of each pool is determined not to be equilibrated (S525, S540), it may be determined that samples to be included on the 2D matrix are all pooled but one of the samples is pooled in a smaller quantity than a quantification limit (S540).

When the pooling of each pool is equilibrated, it is determined that the pooling is normal even if the number of classified groups of the chromosome strands is not equal to the expected number of chromosome strands. The number of classified groups of the chromosome strands may not be equal to the expected number of chromosome strands in a case where samples having the same chromosome strand exist in large quantities. However, according to an embodiment of the present invention, as many regions as possible are independently tested using a window sliding method. Therefore, most of pooling tests are experimentally determined to be equilibrated.

If the pooling of each pool is not equilibrated, the pooled samples need to be reexamined for standard variant detection. The reason of the reexamination is that even if there is a sample demonstrating a positive reaction with respect to the standard variant in a case where there are samples left out in pooling or the samples are pooled in a smaller quantity than the quantification limit, the sample may not demonstrate a positive reaction in the pooling test.

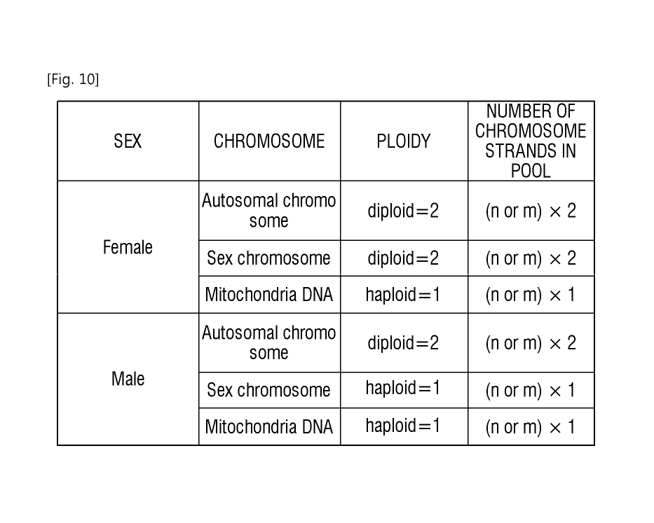

Therefore, in S545, target samples to be reexamined are selected for standard variant detection (S505) and the error samples are reexamined in S550. The target samples to be reexamined are selected from samples positioned at intersections of rows and columns in the pool determined as having a pooling error on the 2D matrix (S545). The target samples to be reexamined will later be described in more detail with reference to FIGS. 10 and 11.

FIG. 6 is a flowchart illustrating a process (S512) of analyzing chromosome strands on the basis of a base sequence in the method illustrated in FIG. 5.

Classifying chromosome strands is ultimately for the purpose of obtaining the number of haplotypes of each pool. There may be homologous chromosomes not classified as the same haplotype. That is to say, some homologous chromosomes may have different types of chromosomes. In some cases, homologous chromosomes having different types of chromosomes may express characters derived from only one among the chromosomes.

The process (S512) of analyzing chromosome strands will now be described. First, if a sample-specific variant is known, reads having the sample-specific variant are classified as one and the same group (S5120). Here, since the rest reads, except for the reads having the sample-specific variant, are not used for classification, they are selected as target reads for classification (S5120).

According to another embodiment of the present invention, DNA fragments distinguished from individual samples in pooling may be inserted into DNAs of the individual samples to then be captured. Such a DNA sequence is designed as a sample-specific variant, and chromosome strands having the designated sample-specific variant are first sorted in classifying the chromosome strands of the samples, thereby facilitating the operation.

A window region for comparison is establish in the reference base sequence (S5121). Two factors, including an offset of the reference base sequence and a size of the window region for determining how many base sequences are to be included in the window region, are required in establishing the window region. A region having high heterogeneity may be determined as the offset of the reference base sequence. A gene has a region without a considerable change between different individuals but still has a highly heterogeneous region demonstrating a distinct difference between different individuals. Since chromosomes should be classified based on base sequences contained in the window region and the number of classified chromosomes should correspond to the number of chromosome strands contained in the pools as the result of classification, it is necessary to establish the region having high heterogeneity as the window region.

The rest reads, except for the reads classified into groups based on the sample-specific variant, are screened and the reads having the same variant are classified as the same group by mapping base sequences included in the window region established in S5121 for the target reads for classification (S5122).

After the group classification of all of the reads is completed, the reads belonging to the same group are reconstructed by base composition, thereby constructing the chromosome strands (S5123). The window region used for classification in S5121 is shifted for the chromosome strands reconstructed by group, and if base sequences included in the shifted window region have different variants in the same group, the base sequences based on, the base sequences are divided into two or more groups (S5124).

The number of chromosome strands of the pools may be calculated based on the total number of groups classified in the above-described manner (S5125).

FIG. 7 is a flowchart illustrating a process of classifying haplotypes on the basis of a window region (710) of a reference base sequence according to an embodiment of the present invention.

The window region 710 is a region of a reference base sequence for comparison for detecting a variant having a different base sequence from the reference base sequence. In an example illustrated in FIG. 7, a region of the reference base sequence, including a gene at position No. 82 (711) to a gene at position No. 87 (712), is established as the window region 710.

In the example illustrated in FIG. 7, the window region 710 is established to have a size defined to include 6 genes. The size of the window region should be set so as to include more than the minimum number of required variants. The minimum number of required variants can be obtained by the following formula (1):

$$Minimum number of required variants = {log}_{( A )} \frac{C}{B} . \qquad ( 1 )$$

In order to secure as many haplotypes as the expected number of chromosome strands, the size of the window region should be large enough to include a sufficient number of variants to divide the reads having different base sequences into different groups. This is attributed to ability of constructing intrinsic chromosome strands of samples using base compositions occurring to variants.

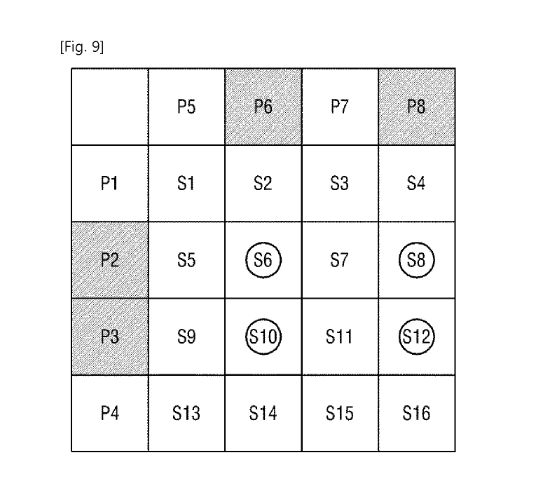

In formula (1), A represents the number of combinations of alleles, B represents the variant occurrence frequency, and C represents the number of chromosome strands contained in the pool. The number of combinations of alleles refers to the number of base types possibly occurring to the respective variants, and the variant occurrence frequency refers to a probability of occurrences of variants in a single base. The number of chromosome strands contained in the pool may be obtained using ploidy data of the respective samples, which will later be described in more detail with reference to FIG. 9.

An exemplary experiment was carried out to investigate how many variants should be included in a window region to construct a sufficient number of chromosome strands, which are required to allow for sample distinction. Here, pooling tests were performed on the human leukocyte antigen (HLA) region having high heterogeneity (1096 bp) using an 8*8 matrix. The HLA gene region correspond to an autosomal region and the expected number of chromosome strands from the pool of 8 samples is 16; C=16.

The variant occurrence frequency of a single base variant in the HLA gene region from an unpooled sample was confirmed to have a value of approximately 0.06: B=0.06. The minimum number of required variants is known to be 9 through substitution of the B and C values in Formula (1). When the size of one window region of the HLA gene region is at least 150 bp, 9 variants may occur so as to construct a sufficient number of chromosome strands for allowing for sample distinction, suggesting that the reads should have a size of at least 150 bp.

In the aforementioned exemplary experiment, when chromosome strands are classified using the HLA gene region in the pooling tests performed using the 8*8 matrix, sequencing should be performed through a window region having a minimum read size of 150 bp to construct chromosome strands enabling sample distinction and proper management of pooling quality. However, the read may have a shortened length in constructing the chromosome strands due to existence of a sample-specific variant or use of information on linkage-disequilibrium (LD).

The aforementioned formula and exemplary experiment are provided only for illustration of the present invention, but aspects of the present invention are not limited thereto.

Referring back to FIG. 7, in haplotype 2, a single base variant T, not C, occurred to the gene at position No. 82. If there are reads having a single base variant occurred to the gene at position No. 82 in mapping of the window region of the reference base sequence, the haplotype 1 is divided to produce haplotype 2, and the reads having a single base variant occurred to the gene at position No. 82 are classified into a group of haplotype 2.

As illustrated in FIG. 7, the window region 710 is a region including the genes at position Nos. 81 to 86. Then, when the mapping with the base sequences included in the window region 710 is completed, the window region 710 is shifted such that it includes genes 711 to 712 at position Nos. 71 to 87. In the shifted window region, reads are further mapped with the reference base sequence, and if there are reads having different base sequences in the same haplotype, the haplotype may be divided into two or more.

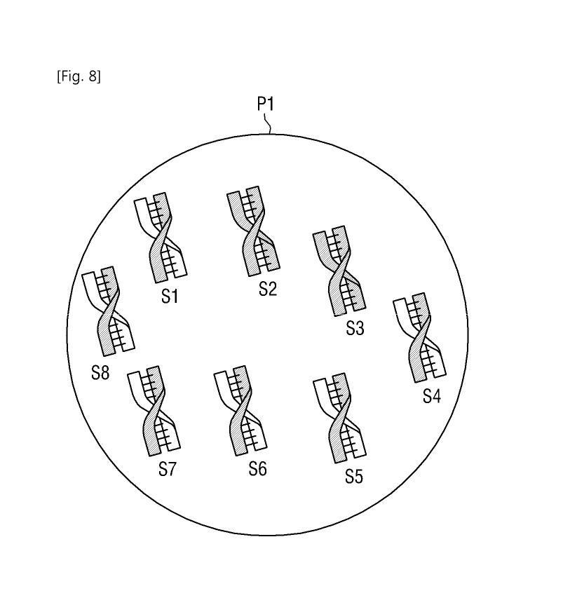

FIG. 8 is a diagram illustrating a process of determining whether pooling is equilibrated from allele frequency according to an embodiment of the present invention.

In order to determine whether pooling of samples is equilibrated, it is necessary to measure allele frequencies. Information on many variants may be provided in constructing a single chromosome strand. The number of allele frequencies of the respective variants should be equal to the number of allele frequencies of variants observed in actually constructing chromosome strands.

FIG. 8 is a diagram illustrating an example of 8*8 pooling tests performed on male autosome samples. As illustrated in FIG. 8, P1 represents one of pools used in 8*8 pooling tests. An assumption is made that male autosome samples are pooled in the pool P1. Therefore, 16 chromosome strands are included in the pool P1.

In the exemplary embodiment illustrated in FIG. 8, among chromosome strands of the respective samples, let the chromosome strands in white be variant-including chromosome strands A. Assuming that an allele frequency value of the variant-including chromosome strands in one window region is 0.5, 8 among 16 chromosome strands constructed should have alleles of the variant A. However, only 6 chromosome strands, not 8 chromosome strands, are observed in the pool P1 of FIG. 8. Therefore, the pooling of the pool P1 may be determined not to be equilibrated.

The number of allele frequencies of the respective pools should be equal to occurrences of variants to the respective chromosome strands. The allele frequencies of the respective pools are obtained in S505. The allele frequencies observed in the chromosome strands may be obtained by determining how many variant-including chromosome strands are actually detected, as illustrated in FIG. 8.

FIG. 9 is a diagram illustrating a process of determining ploidys for explaining sample ploidy designation.

As illustrated in FIG. 9, each two strands of sex chromosome and autosomal chromosome and one strand of mitochondrial DNA exist in a female sample, while two strands of autosomal chromosome and each one strand of sex chromosome and mitochondrial DNA exist in a male sample. The number of chromosome strands of a sample is determined by the ploidy type of the sample. The expected number of chromosome strands is determined by the following formula (2):

Expected number of chromosome strands contained in pool=Σᵢ₌₁^{(n or m)} number of chromosome strands of sample i (2).

The result value of the expected number of chromosome strands determined by the following formula (2) can be used in determining the minimum number of required variants in the formula (1).

FIGS. 10 and 11 illustrate examples of cases where samples with pooling errors cannot be discriminated and where samples with pooling errors can be discriminated in the method for pooling error detection according to an embodiment of the present invention.

If it is determined that there is a pooling error (S520, S525), target samples to be reexamined are selected (S545). The target samples to be reexamined may include some of the samples contained in the pools or all of the pool. The basis for selecting the target samples will now be described with reference to FIGS. 10 and 11.

In the example illustrated in FIG. 10, assumptions are made that allele frequencies of four pools P2, P3, P6 and P8 are measured and that it is determined in S520 that pooling is not equilibrated, In this case, all of four samples S6, S8, S10, S12 may have exerted influences on pooling errors, or pooling errors may be detected from only the samples S6 and S12 or from only the samples S8 and S10. However, since it is not possible to decisively determine one among the three cases, error samples cannot be discriminated. Therefore, in the embodiment illustrated in FIG. 10, all of the samples S6, S8, S10, S12 are selected as the target samples to be reexamined (S545). Then, standard variant detection is again performed on the selected target samples (S550).

FIG. 11 illustrates an example of a case where samples with pooling errors can be discriminated in the method for pooling error detection according to an embodiment of the present invention.

In the example illustrated in FIG. 11, assumptions are made that allele frequencies of four pools P2, P3, P6 and P8 are measured to determine whether pooling is equilibrated (S520) and that the pools P2 and P6 are pooled not in an equilibrated manner. In this case, the sample S6 can be discriminated as an error sample. Therefore, the sample S6 is selected as a target to be reexamined (S545), and standard variant detection is again performed on the selected target sample S6 (S550).

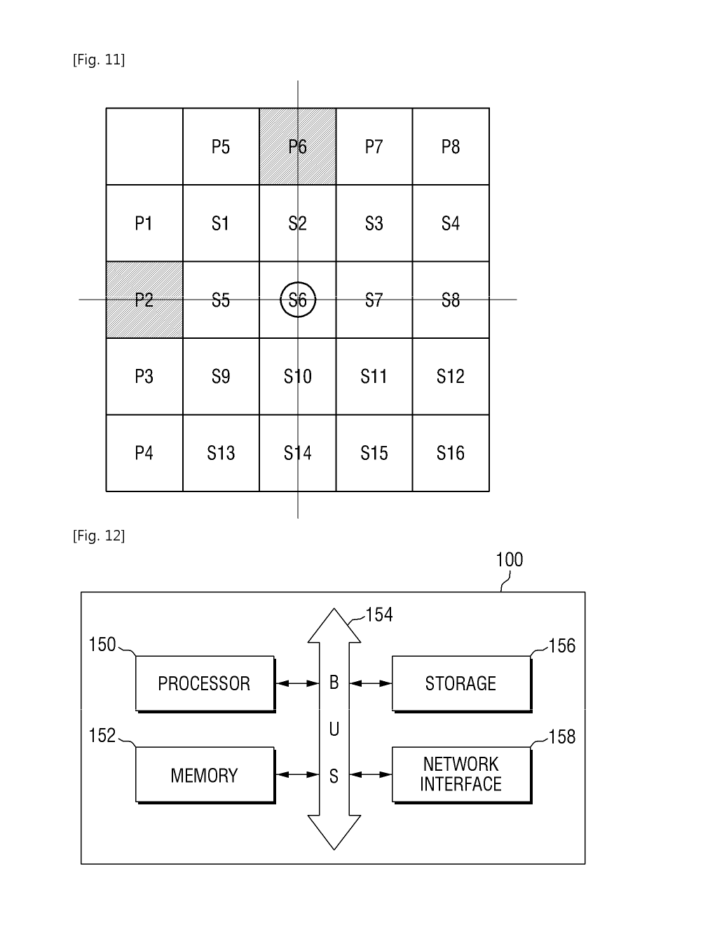

FIG. 12 is a hardware diagram of a pooling error detection apparatus according to an embodiment of the present invention.

The pooling error detection apparatus 100 may have the same configuration as illustrated in FIG. 4.

The pooling error detection apparatus 100 may include a processor 150 for executing various instructions, a storage 156 in which a computer program for verifying a pooling test result and a pooling error detection result is stored, a memory 152, a network interface 158 for transmitting/receiving data to/from an external device, and a system bus 154 connected to the storage 156, the network interface 158, the processor 150 and the memory 152 and functioning as a data movement passageway.

The computer program for verifying the pooling error detection result may include a series of first determining instructions of calculating the expected number of chromosome strands from ploidy types of the respective samples, detecting kinds of chromosome strands having different genotypes based on genotypes of the respective samples and determining whether the number of detected chromosome strands is different from the expected number of chromosome strands; a series of second determining instructions of extracting an allele frequency value for a standard variant from the pool and second determining whether the pooling is equilibrated using the allele frequency value; and a series of error detecting instructions of determining whether a pooling error is detected based on results of the first determining and the second determining.

When the samples are abnormally pooled, the computer program may further include a series of instructions for selecting only abnormal samples and performing standard variant detection again on the abnormal samples.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A method for detecting a pooling error comprising:
determining an expected number of normal chromosome strands of a plurality of samples contained in a first pool based on ploidy types of the plurality of samples;
determining whether a number of normal chromosome strands is different from the expected number of chromosome strands determined based on base sequences of the plurality samples contained in the first pool;
determining whether pooling is equilibrated based on an allele frequency value for a standard variant of the first pool;
detecting a pooling error using results of the determining the number of normal chromosome strands and the determining whether the pooling is equilibrated; and
generating an output signal corresponding to determining whether the pooling error is detected.

2. The method of claim 1, wherein the determining the number of the normal chromosome strands in the first pool comprises:
receiving base sequence data for a plurality of reads corresponding to the plurality of samples contained in the first pool;
grouping a sample-specific variant group of the plurality of reads, the sample-specific variant group of reads having base sequences corresponding to a preset specific variant among the plurality of reads;
establishing a window region for a reference base sequence as a basis for determining whether there is a variable;
grouping a remaining group of the plurality of reads, the remaining group of reads having a same variant in the window region of the reference base sequence, and not belonging to the sample-specific variant group; and
calculating the normal number of chromosome strands in the first pool according to the total number of groups based on the grouping the sample-specific variant group and the grouping the remaining group of the plurality of reads.

3. The method of claim 2, wherein the establishing the window region comprises establishing the window region to have a minimum number of required variants calculated by the following formula:
$$minimum number of required variants = {log}_{( A )} \frac{C}{B} ,$$
where A represents a number of combinations of alleles, B represents a variant occurrence frequency, and C represents a number of chromosome strands contained in the first pool.

4. The method of claim 2, wherein the grouping the remaining group of the plurality of reads comprises:
shifting the window region; and
in response to chromosome strands belonging to one group in the window region of the shifted reference base sequence have different variants, dividing the chromosome strands belonging to one group into two or more groups.

5. The method of claim 1, wherein the determining whether the pooling is equilibrated comprises:
obtaining a plurality of base sequences corresponding to the standard variant;
measuring a number of chromosome strands having the plurality of base sequences corresponding to the standard variant; and
determining whether pooling is equilibrated using the allele frequency, pools in which the measured number of chromosome strands corresponds to the standard variant, and the determined expected number of chromosomes.

6. The method of claim 1, wherein the detecting the pooling error comprises:
in response to the pooling being determined to be equilibrated, determining the pooling as normal pooling;
in response to the pooling being determined not to be equilibrated and the determining the number of normal chromosome strands indicating that the number of normal chromosome strands is equal to the expected number of chromosome strands contained in the first pool, determining that particular samples are pooled in a smaller quantity than a quantification limit in the pooling, and determining that there are errors in the pooling.

7. The method of claim 6, wherein the determining that particular samples are pooled in the smaller quantity than the quantification limit in the pooling, further comprises discriminating the particular samples by comparing the number of chromosome strands contained in the first pool with a second number of chromosome strands and a second allele frequency of a second pool crossing the first pool on a two dimensional matrix.

8. An apparatus for detecting a pooling error comprising:
at least one processor;
a network interface; a memory; and
a storage device loaded on the memory and having a computer program recorded therein executable by the at least one processor,
wherein the computer program causes the apparatus to execute:
calculating an expected number of chromosome strands of a plurality of samples in a first pool based on ploidy types of the plurality of samples, detecting chromosome strands having different genotypes based on genotypes of the plurality of samples, and determining whether the number of detected chromosome strands is different from the expected number of chromosome strands;
extracting an allele frequency value for a standard variant from the first pool and determining whether the pooling is equilibrated based on the allele frequency value;
determining whether a pooling error is detected based on the determining whether the number is detected chromosome strands is different and the determining whether the pooling is equilibrated; and
generating an output signal corresponding to the determining whether the pooling error is detected.

9. A method for determining a number of haplotypes contained in each of a plurality of pools, the method comprising:
receiving base sequence data of a plurality of reads respectively contained in each of the plurality of pools;
constructing a corresponding plurality of chromosome strands contained in each of the plurality of pools using the corresponding base sequence data for each of the respective reads;
designating a corresponding remaining group of the plurality of chromosome strands, excluding reads having base sequences corresponding to a preset specific variant, among the corresponding constructed plurality of chromosome strands, as corresponding chromosome strands to be classified;
establishing a corresponding window region for each of the plurality of pools as a reference base sequence as a corresponding basis for variable determination;
classifying the corresponding chromosome strands to be classified into corresponding groups of chromosome strands having the same variant based on DNA base sequences in the corresponding window region of the reference base sequence;
calculating the corresponding number of chromosome strands in each of the plurality of pools based on the corresponding classifying result; and
generating a plurality of output signals corresponding to the calculating the corresponding number of chromosome strands in each of the plurality of pools.

10. The method of claim 9, wherein the establishing the corresponding window region of the reference sequence comprises establishing a corresponding minimum number of required variants calculated by the following formula:
$$minimum number of required variants = {log}_{( A )} \frac{C}{B} ,$$
where A represents a number of combinations of alleles, B represents a variant occurrence frequency, and C represents a number of chromosome strands contained in the corresponding pool.
